(19) United States
(12) Patent Application Publication
(10) Pub. No.: US 2014/0279516 A1
(43) Pub. Date: Sep. 18, 2014

(54) AUTHENTICATING A PHYSICAL DEVICE

(71) Applicants: Nicholas Rellas, Sherborn, MA (US); Justin Robinson, Cambridge, MA (US); Spencer Frazier, Boca Raton, FL (US); Theodore Kuklinski, West Newton, MA (US); Brandon Currul, Medway, MA (US)

(72) Inventors: Nicholas Rellas, Sherborn, MA (US); Justin Robinson, Cambridge, MA (US); Spencer Frazier, Boca Raton, FL (US); Theodore Kuklinski, West Newton, MA (US); Brandon Currul, Medway, MA (US)

(21) Appl. No.: 13/831,143

(22) Filed: Mar. 14, 2013

(51) Int. Cl. G06Q 30/00; G06Q 20/40

(52) U.S. Cl. CPC G06Q 30/0185; G06Q 20/4014
USPC 705/44; 705/318

(57) ABSTRACT

Among other things, a physical device is determined to be validly issued by a party that issues physical devices that include security features. At least a portion of a photographic or video image of the physical device is processed automatically to determine if the physical device includes at least one of the security features.

This application relates to U.S. application Ser. No. 13/742,009, filed Jan. 15, 2013 and Ser. No. 13/742,004 filed Jan. 15, 2013, which are incorporated here by reference in their entireties.

### BACKGROUND

This description relates to authenticating physical devices.

Driver's licenses, for instance, are physical devices that are sometimes authenticated (that is, checked to confirm that they are what they purport to be) as part of a process that involves using information that is contained on or represented by the physical device.

For example, suppose a server at the Union Oyster House is shown a Massachusetts driver's license by a young woman who wants to order a bottle of Sam Adams Light. The server may casually try to determine that the driver's license is, in fact, a Massachusetts driver's license (“it looks like one”) and that it is the driver's license of the customer (“the picture on the license looks like her, sort of”). In this way, the server tries to authenticate the license. Then she will look at the birthdate on the license to confirm that the customer is at least 21 years old and therefore allowed to order a beer in Massachusetts.

Many other kinds of physical devices can be authenticated and information that they contain or represent be used for a variety of purposes. For example, a clerk at a store can authenticate a $100 bill as having been issued by the Federal Reserve Bank and then accept that “100” on the bill as a correct measure of the value represented by the bill.

Many different approaches can be used to authenticate a physical device. For instance, a bouncer at a club may hold a driver's license under an ultra-violet (UV) light to look for certain patterns that are made visible under UV light.

### SUMMARY

In general, in an aspect, a physical device is determined to be validly issued by a party that issues physical devices that include security features. At least a portion of a photographic or video image of the physical device is processed automatically to determine if the physical device includes at least one of the security features. Implementations may include any of the following features or combinations of any two or more of them. The physical device includes an identification device. The physical device includes a driver's license. A question is presented to a user based on information derived from the physical device. The photographic or video image is captured. The photographic or video image is captured by a camera of a mobile device. Information about the valid issuance of the physical device is displayed to a user. The issuing party includes a governmental body. The issuing party includes a bureau of motor vehicles. The security features include symbols or characters. The security features include words or phrases. The security features include patterns. The security features include microprint. The security features include spacing between symbols, characters, or lines. The portion of the photographic or video image is processed by sharpening, enhancing, rotating, skewing, cropping, or de-noising, or combinations or two or more of them. Processing includes reading a barcode. Processing includes optical character recognition. Processing includes classifying the physical device using optical character recognition. Information about an individual is extracted from the physical device using optical character recognition. Processing includes pattern matching. At least the portion of the photographic or video image is compared to a reference photographic or video image. Processing includes template matching. Processing includes the use of super resolution techniques. Processing is based on vision libraries. A score is determined. The score is at least in part based on a probability that the physical device was validly issued by the issuing party. The score is at least in part based on a probability that an individual purporting to be associated with the physical device is associated with the physical device. The physical device includes a payment device. The physical device is used to determine information about a person who is associated with the physical device. The information about the person includes identification information. A person who has a purported identity and is associated with the physical device is determined to have an actual identity that matches the purported identity. Determining that the person's actual identity is matched to the purported identity includes receiving information from the person independently of information that is part of the physical device. Information about a person who is associated with the physical device is derived from the physical device, and it is determined if there is a match between the derived information and the actual identity of the person.

In general, in an aspect, an individual identified by a physical identification device is determined to be is associated with a mobile device that is identified by a unique token. Identification information is derived from at least a portion of a photographic or video image of the identification device. The unique token is used to determine an identity of a customer who is associated with the mobile device. The identity of the customer is compared with the identification information derived from the identification device. Implementations may include any of the following features or combinations of any two or more of them. The identification information includes a photograph. The identification information include symbols or characters. The mobile device includes a mobile phone. A photographic or video image is captured using the mobile device. The unique token comprises includes phone number. The unique token includes a universally unique identifier. The unique token includes a media access control address. The unique token is used to identify the customer at a location other than the location of the mobile device. The unique token is used to identify the customer using customer records of a telecommunications company.

In general, in an aspect, a camera is used to capture an image of an identification device. At least a portion of the image is compared to images of officially issued identification devices to determine whether the presented device is, within a forensic standard, an officially issued identification device. An indication is provided indicating whether the presented identification device is determined to be an officially issued identification device.

In general, in an aspect, a mobile device is used to capture an image of an identification device. Features captured in the image are automatically compared to known features of validly issued identification devices of an issuing entity to determine whether the presented identification device was, within a forensic standard, issued by the issuing entity.

Implementations may include any of the following features or combinations of any two or more of them. Information derived from the identification device is automatically compared to information from other sources to determine whether the identification device identifies an individual it purports to identify. The information derived from other sources includes email or phone contacts. The information derived from other sources includes customer information associated with the mobile device. The information derived from other sources includes information in the control of a fraud detection service.

In general, in an aspect, an image of a physical device captured using a mobile device is obtained. Information is derived from at least a portion of the image of the physical device. The identity of the individual associated with the mobile device is compared with information derived from the physical device.

In general, in an aspect, an activity is initiated which, to complete, requires identification of the initiating individual. A mobile device is used to capture an image of an identification device. The activity is completed. In some implementations, the activity is an online purchase.

These and other aspects, features, and implementations, and combinations of them, can be expressed as methods, apparatus, systems, components, program products, business methods, and as means and steps for performing functions, and in other ways. These and other aspects, features, implementations, advantages will become apparent from the following description, and from the claims.

### DESCRIPTION

FIG. 1 is a flowchart.

FIG. 2 is a block diagram.

FIGS. 3-10 are wireframes.

Some implementations of the system described here provide a multi-faceted approach to authenticating physical devices. In many cases the physical devices are cards or tokens (driver's licenses or passports or tickets, for example) that identify or are otherwise associated with a person who possesses the device. Some examples of the system that we describe can associate the physical devices with the people who possess them (the picture on the driver's license looks like the person who had it in his pocket, for example), and also derive information about or associated with the people who possess them from the physical devices (the driver's license says that he lives in Rock Creek, Va. and is 22 years old, for example).

In some cases, the system may be able to associate an identification device with a mobile device (such as a cell phone or portable tablet) so that individuals can, for instance, “put their ID on their phone.” For instance, a person may be able authenticate his ID using an application in his phone, with the phone storing that information. After that, the person may be able to use his phone to prove that he is old enough to buy alcohol, without having to produce his ID again.

In some examples, the system can use a variety of techniques, including computer vision technologies, device-specific tokens, personally identifiable information, and advanced security features to provide a “confidence threshold” or “best guess” of the security of proposed transactions, including those occurring over the mobile space.

Examples of the system may be able, among other things, to authenticate or verify that (1) a physical device is validly issued, regardless of who owns the physical device or whether the owner is the person who presented it (sometimes referred to as identification device authentication); (2) the person presenting the device is the person he claims to be (e.g., the name entered in a form matches the person who typed it), regardless of the information contained in the physical device (sometimes referred to as individual identity authentication); or (3) the physical device refers to the person presenting the device (sometimes referred to as matching the individual to the identification device). Depending on the implementation, the system may be able to accomplish one or a combination of any two or more of these tasks and others. Some implementations may be able to accomplish all three. We use the terms “verify” and “authenticate” interchangeably and broadly. Sometimes we use one or the other of the terms verify and authenticate to refer to one or any combination of two or more of the activities listed in (1) through (3) above.

In some implementations, the results of the authentication or verification may be presented to a third party, which may be the party requesting the authentication or verification. In some implementations, the system will perform sufficient checks and provide sufficient feedback (sometimes in the form of a score or warning, as discussed below) so that the third party can make a decision about an individual being verified. For instance, the third party may receive sufficient information about the individual to consider the individual “verified” and allow the individual to make a purchase, or login to or register for the third party's service.

In an example of our system, Carl may wish to buy beer online. To do this, Carl may have to prove to the beer seller that he is over 21. Carl may have a driver's license from the state of Massachusetts showing that he is 35. Carl can take a picture or video of his driver's license using his mobile phone, and use some implementations of this system to authenticate the license, that is (a) confirm that the driver's license is valid (that it is a validly issued Massachusetts license), and (b) assure that it is indeed Carl who is presenting the license, and (c) confirm that the license belongs to a particular person, in this case Carl (that Carl's name and other information is displayed on the driver's license). This system may be used directly by Carl rather than requiring another person to intercede in the process, with the results presented to the remote beer seller, or may be used by a beer seller who is handed Carl's license (or a picture or video of Carl's license).

As discussed below, the system has potential applications in a wide variety of fields other than authenticating the driver's licenses of alcohol customers. For instance, the system can be used to identify individuals applying for mortgages or passports, making large purchases, or purchasing airline tickets, among a broad spectrum of applications.

We use the terms “ID,” “identification device,” “ID document,” “ID card,” and “identification token,” among others, interchangeably and broadly. All refer to identification devices. We use the term “identification device” in its broadest sense, to include, for instance, driver's licenses, passports, visas, green cards, military ID cards, building passes, student IDs, key fobs, membership cards, loyalty cards, social security cards, birth certificates, credit cards, debit cards, or any other physical object issued by an issuing authority that is meant to identify or be uniquely associated with an individual or group of individuals. The issuing authorities may be a government, a corporation or other business entity, a university, a landlord, or an organization, among others.

Some implementations of the system have applications beyond authenticating identification devices. Examples of the system can be used to verify that, for instance, a $100 bill, a ticket to a Broadway show, a bank check, or a marriage certificate is not forged or counterfeit. Examples of our system may be used to verify that an ancient artifact is indeed ancient (and not a modern reproduction), or may be used to verify signatures.

FIG. 1 is a flowchart of features of some implementations of our system. In some examples, a user initiates a process or a transaction, such as downloading an application or visiting a secure website for some third party merchant or service (step 100). For example, the user may go to a website to make a purchase, join an online gambling site, or apply for a credit card or a visa for international travel. In some cases, the user may physically enter a store to make a purchase or obtain a service.

We use the terms “merchant,” “service,” “store,” “payment processor,” and “service provider” interchangeably and broadly. All refer to individuals or entities interested in the verification of the user's ID or identity, including sellers, retailers, cashiers, website owners, government officials, police officers, security guards, school officials, testing proctors, service providers, bus drivers, conductors, station attendants, ushers, attendants, bouncers, and ticket checkers, among others.

In some examples, to register the user whose physical device is to be authenticated, the website or service may prompt the user for some data, such as “Name,” “Address,” or “Date of Birth.” In some implementations, the user inputs this information, sometimes referred to as the “form data” (step 102). After inputting the form data, the user may be prompted to have his identity verified (e.g., the user may be prompted to be “Verified by Mident”). By starting this process, the user creates a secure session with the system processor server generating a public and private session code for referencing the verification transaction. In some cases, the user may be asked to verify the data input in step 102 (step 104). This may be a pop-up screen or a check box.

The user may then be prompted to take a picture of the front of his ID. This “picture” may be a raw data stream from the camera of device (e.g., the phone or computer) including image, sound, or video material or combinations of any two or more of those. The raw data stream can represent pixels captured by a sensor of the camera in a single image, or pixels of a series of such images, or audio information captured by a microphone on the device, or combinations of those. Once the user takes the picture (step 106), preliminary template matching may be used on the pixel data to categorize the ID (step 108). For instance, the ID may be categorized by type of ID (e.g., a driver's license or a passport), by sub-type (passport nationality or driver's license state), or both. Further categorizations may occur, for instance, to determine if it is a new version or an old version of a certain state driver's license, or to determine if it is an under-21 license or an over-21 license.

In some cases, preliminary optical character recognition (OCR), barcode scanning, or pattern matching may be performed on the pixel data to extract text that appears on the front of the ID. Fuzzy matching can be used to match the information to information expected to be seen on the ID as represented by the given form data (step 110). For example, the system may determine if the name entered in step 102 matches the name on the ID. If the name does not match, the user may receive a prompt or warning. In some cases, the user will not be able to proceed if there is a mismatch. In some cases, the user will be able to proceed, but the merchant or service may be notified of the mismatch. In some cases, the system may simply change the form data (entered in step 102) to conform to the name on the ID. In some cases, a mismatch will lower the overall score or best guess of the security of a given transaction (discussed below).

The user may then be prompted to take a picture (in a similar sense) of the back of his ID. Once the user takes a picture of the back of the ID (step 112), preliminary OCR, barcode scanning, or pattern matching, or a combination of those, could be used to extract information from the back of the ID and data in a barcode (step 114). Some IDs have barcodes that encode information (like name and date of birth), so this information can also be referenced. In some implementations, the user takes a picture of the back of the ID (step 112) before information is matched to the form data (step 110), for instance, to make sure that the text on the front of the ID matches the information encoded in a barcode on the back of the ID. In some implementations, an auxiliary device could be used to provide additional information, such as information encoded in a magnetic stripe or embedded chips, which can be referenced.

In some implementations, in the background, the system collects a device-specific token (e.g., a code unique to a particular iPhone) (step 116). This can be a universally unique identified (UUID), or a media access control address (MAC address). This can be visible or hidden device information. This information can be collected in the course of the use of the device by the individual to interact with the authentication application. The UUID or the MAC address may be associated with the individual in the records of the cellular carrier.

In some cases, the system may collect, encrypt, and categorize information about contacts stored on the phone, recent phone or text conversations, or social network information (step 118). The information can be collected in the course of the individual's use of the phone to interact with the authentication application. This data may be cross-checked by the system with other information gathered to verify the identity of the individual user.

In some implementations, the user may input a signature (e.g., signed with his finger or a stylus) or biometric data, such as a voice recording, picture of the user's face, retinal scan, or fingerprint, or a combination of two or more of those or others (step 119). The signature or biometric data may be stored as a security pass for future sessions, or referenced against data or information entered in the current or a previous session (or both). For instance, the user may take a photo of his face with a front-facing camera on his mobile phone, and the picture of the user's face may be matched, with facial imaging techniques, to a picture on the presented ID. The user may sign the surface of his smartphone with his finger, and the signature may be compared to the signature on the presented ID (e.g., the signature on a driver's license). The user may be prompted to create a depth-mapping image from multiple angles to make sure the person is actually present. In some implementations, the user may be prompted to input a stored, known, biometric tag associated with the user, much like a security phrase. This could be a stored security phrase or password, a facial image, or a fingerprint, among other biometric data. For instance, the user could input a stored security phrase, which could be a phrase of the user's choice or a phrase chosen by a system administrator (e.g., the service provider or the system processor). Facial recognition, passphrase comparisons, and other biometric security techniques may be performed locally (e.g., at the merchant's application) or may be performed on the system processor server, or some combination of those and other locations. In some implementations, biometric data is stored and encrypted locally within the merchant application.

Information associated with the verification session, such as the video or picture of the front of the ID, the video or picture of the back of the ID, the form data, biometric data, or the background data (e.g., phone contacts or social network information), may be sent to the system processor server (step 120). The system processor server may process or sharpen any images or data, and conduct visual analysis and data retrieval (step 122). The IDs may be checked for certain security features to verify that the IDs are validly issued (or to determine that the ID is invalid or questionable). These security features may be known at the server to be associated with validly issued IDs. For instance, the system may check for certain microprint (small text, which may require a magnifying glass to read) or use image analysis tools (pattern matching) to detect known security features in the data representing the images or video. As an example, the system may check that the border of a Massachusetts license contains the words “State of Massachusetts” written in small text, or may check that two lines in the top right corner are spaced exactly one millimeter apart. A wide variety of other security features (and combinations of two or more of them) used on physical devices and often not easily seen by the naked eye or understood by a typical observer can be checked.

In some implementations, in addition to or alternatively to one or more of the checks that we describe, the form data or data extracted from the ID is sent to a third party fraud analysis, detection, or prevention service (step 124), which may return more information to be matched with the given data and a challenge question. In some cases, the data sent may be cross referenced against stored information to make sure that the information provided represents a real individual. An example of this type of service is EVS (Electronic Verification Systems, located in Louisville, Ky.), a service used by some law enforcement agencies. This verifies that the person described by the ID exists, may provide more data to match with the collected information to make that determination more certain, and provides a challenge question to verify that the person presenting the ID is associated with the ID. The challenge question can be based on information known to the service through independent sources. Example challenge questions include: What was the make and model of the last car you purchased? Where did you last apply for a mortgage? Where were you born? The challenge question may be presented to the user and his response encrypted and sent back to the third party fraud analysis service to determine if the answer is correct (step 126). In some implementations, the answer to the challenge question is sent to the third party service to check for correctness. In some implementations, the answer to the challenge question may have been supplied with the challenge question for local use, and the answer can be checked without requiring another query to the service.

In some implementations, phone or email contacts may be cross-referenced with social media contacts (step 128). The system may generate an overlap score, which further verifies that the individual exists and is associated with the device.

In some examples, the device-specific token (collected in step 116) and some user information (e.g., the user's name) are sent to the telecommunications (TC) company (e.g., a cellular service provide) associated with the device (step 130). The device account information may be compared to the given data (e.g., the user's name). If there is a match, this result may be returned to the system processor server and stored for that session. For instance, the MAC address associated with an iPhone and the name John Smith may be sent to Verizon. Verizon then checks the account information associated with that MAC address, and confirms that John Smith is the account holder.

Some implementations of the system generate a score, which may be a confidence threshold or “best guess” of the accuracy of the outcome of the verification process (step 132). For example, the system could indicate that the driver's license is a valid New York license and that the person who presented it is the owner of the license to a confidence level of 90%. In some cases, past verifications from previous sessions for this user may be weighted and added to the aggregate of the analysis to create a cumulative “score” for the user. All individual checks that are passed or failed may also be assigned scores. For example, an individual score may be generated when the form data is compared to the text on the front of an ID, which may be factored into the overall score. The individual or overall scores, or both, may then be provided to the merchant or service provider, who can determine whether the score is “good enough” to allow the user to make a purchase or enjoy a service (step 134).

In some cases, a merchant or service provider for whose benefit authentications are being done may program or build an application to require a certain minimum or threshold confidence score on the authentication outcomes. For example, a merchant or service provider may have a blanket threshold score value needed to make a purchase or receive a service. This may be a score of 5 out of 10, or a score of 80%, or three out of five stars. In some cases, if a user has a score below that threshold, he will be unable to make a purchase or receive the service. Or, the user may be required to pay more for the item or service because of the uncertainty to the merchant or service provider. A service provider may have varying thresholds depending on certain criteria—e.g., number of previous purchases by that individual, time of day or year, age, sex, or geographic area. Thus, a merchant may require a threshold of 8/10 in New York, but only a threshold of 6/10 in Kentucky. The threshold may vary depending on the laws of a geographic location, or the probability of a fraudulent transaction in general. The threshold may also change over time.

Upon completion of the validation process, the score and relevant check information may be sent from the system processor servers to the merchant for use in its site, service, or application. In some implementations, it is within the discretion of the merchant to determine thresholding (e.g., the minimum score needed for the user to proceed). In some implementations, the system processor servers may inform the merchant whether the individual's identification “failed” or was successfully “verified.” In some examples, once the merchant specifies the thresholds, the system proceeds automatically to act on any verification outcome that meets the threshold, without further agreement of the merchant. In some cases, the system could provide the decision to the merchant for every verification session and allow the merchant to approve or disapprove the transaction.

The user may be notified of whether the verification process succeeded in verifying his identity, or failed (step 136). For instance, the user may be presented with a “Verified” or a “Failed” response image on the display of the device. In some cases, the user may only be allowed to complete registration or purchase if he was “Verified.” In some cases, a user may be allowed to purchase or register even if his verification “Failed,” but may incur some penalties—such as higher prices, limited product or service offerings, or limits on the amount of purchases (number of items or total price).

In some cases, the system may be used for collection purposes. For instance, the user may be prompted to input the information for verifying identity during a support troubleshooting session. In some implementations, only the merchant or service provider would see the result (e.g., “Verified” or “Failed” or score). This information could be sent to a secure database accessible by the merchant or service provider.

Not every step is necessary in every implementation, and not every implementation may require the steps to be performed in the sequence described above. For instance, some implementations may not send data to a third party fraud analysis service (step 124). Some implementations may not present the user with a challenge question (step 126). Some implementations may not obtain a device-specific token or present it to a telecommunications company (steps 116 and 130). In some implementations, the user physically hands the ID to another party (such as a cashier, bouncer, or security guard) who captures video or images, or both, of the ID on a device not belonging to the user. A wide variety of combinations of two or more of the features of steps are possible.

FIG. 2 shows a block diagram of an example of our system. Using a user device 200, the user launches a “service provider app” (or website) 202, which may incorporate elements of the system processor's interface and the merchant's or service provider's own interface (e.g., Paypal's mobile interface). The system processor may be the same or a different entity than the service provider. A user launches the app or enters a website that exposes the app to the user (arrow 1). In some cases, the user completes a login or registration form, or adds items to his virtual shopping cart (arrow 2). The service provider app or website 202 sends data to the service provider server 204 (arrow 3), and when the user is ready to complete the transaction, for example, the service provider server 204 will send a message to the service provider application 202 (arrow 4) to prompt the user to begin the verification process (arrow 5).

A user may be required to enter multiple types of information during the verification process, depending on the requirements of the service provider (step 6). For instance, the user may be required to enter an ID document 206 (e.g., a driver's license or a passport), a credit card 208 (or other payment card, such as a debit card), and biometric input 210 (e.g., voice, retinal scan, picture of the user's face, or fingerprints). In some cases, all the information can be captured using the camera 212 (either front or back-facing) or built-in audio microphone 214, or both, on the user device 200 (e.g., mobile device, tablet, phone, or laptop computer). In some cases, hardware add-ons or external devices could be a source of data, such as a magstripe device or a scanner. For instance, the user may take pictures or videos of his ID document 206 and credit card 208. Both documents may be captured with a single picture or video, or may be captured with multiple pictures or videos, or both pictures and videos. In some cases, a user may be able to use an image or video captured previously and stored in a picture or video album. In some cases, the user must provide a picture or video of both the front and the back of the ID document 206 or a credit card 208, or both.

In some cases, the service provider app 202 will verify the credit card 208 using optical character recognition (OCR). This may involve comparing the name on the credit card 208 to information entered in form data (such as in a registration or login form, or in check-out forms). This may involve comparing the name on the credit card 208 to information extracted from the ID document 206. This may involve verifying that the expiration date on the credit card 208 has not passed, and that the credit card number contains the correct number of digits or matches a check digit validation. This may involve verifying that the information printed on the credit card 208 matches information read from a barcode on the credit card 208.

The service provider app 202 may match the data from the front of an ID document 206 to the information scanned from the ID document's barcode (sometimes located on the back of the ID document 206) using computer vision scanning techniques. The information on the credit card 208 may be matched to the ID document 206. The data collected may be compared to the form data, if any, that the user entered earlier within the service provider's app 202 (for instance, in a registration page or checkout screen). In some examples, facial images (biometric input 210) inputted by the user are matched using facial recognition techniques to photographs on the ID document 206. In some cases, no data connection is required for this step. In some cases, the system processor may provide a plugin, software development kit (SDK), or application programming interface (API), or some combination of those, to be incorporated directly into the process flow.

In some implementations, the service provider app 202 will request permission from the user to verify the information provided or to gather other data, or both (arrows 7, 8). For instance, the service provider app 202 may communicate with third party social media API's 216 to verify that the given personal data connects with a variety of social media accounts across multiple networks (arrows 9, 10). This may be information gleaned from Outlook contacts, phone contacts, Facebook accounts, Linkedin accounts, or Twitter accounts, among other sources of information.

The service provider app 200 may then send all or some of the data, in encrypted form, to the system processor server 218 (arrow 11). The system processor server 218 may then conduct automated forensic checks on the presented ID document 206 (possibly both front and back). This may involve, for instance, looking for security features associated with validly issued ID documents, such as the presence of microprint, or the particular placement or spacing of certain characters, symbols, or features. This may also involve pattern matching against a library of validly issued ID documents, such as the library of United States driver's licenses maintained by Advanced ID Detection of Medway, Mass.

The system processor server 218 may send some of the information to third party personal data services 220, like a fraud analysis, detection or prevention service used by law enforcement agencies (e.g., EVS or Lexus Nexus) to verify that the user actually exists (arrow 12). The system processor server 218 may receive back verification for the given data, such as a “verified” or “declined” message (arrow 13). In some examples, the system processor server 218 only sends information to third party personal data services 220 if the ID document is authenticated (e.g., the driver's license is determined to be validly issued from the state it purports to be issued from). In some examples, the system processor server 218 sends information to third party personal data services 220 during or before the authentication process. In some examples, the information sent to the third party personal data services 220 includes a name and a date of birth. In some examples, it includes biometric data 210, such as fingerprints, to be checked against a database of known fingerprints.

If the data reconciles with a real person within the third party database, a challenge question may be sent to the system processor server 218. The system processor server 218 will then send the challenge question to the service provider app 202 (arrow 14) and the service provider app 202 will send the question to the user device 200 to be presented to the user (arrow 15). The user will respond to the challenge question (arrow 16) and the response will be sent to the system processor server (arrow 17) to be passed to the third party personal data service 220 to be checked for correctness (arrow 18). The third party personal data service 220 will inform the system processor server 218 if the answer was correct (arrow 18A).

The system processor server 218 may send device-specific data or a device-specific token (such as a phone's MAC address) to a telecommunications user database 222 to ensure that the phone belongs to the person associated with the user device, credit card or ID document, or the name entered in form data (arrow 19). In some cases, the device-specific data is only sent to the telecommunications user database if the user correctly answered the challenge question. In some cases, the device-specific data is sent to the telecommunications user database even if the user incorrectly answered the challenge question, or if no challenge question was presented. The system processor server 218 will receive a response from the telecommunications user database 222 (arrow 20), for instance, indicating whether the customer associated with the device matches the user information extracted from the ID document 206 or entered into the form data.

In some cases, the system processor server 218 may analyze all of the comparison data and scoring from each party (e.g., service provider application 212, third party personal data service 220, and telecommunications user database 222) to determine an overall “score.” The system processor server 218 may then send that score to the service provider app 202 (arrow 21). In some cases, the service provider app has a threshold or minimum score necessary to allow the user to proceed (e.g., to make a purchase). In some cases, the service provider app 202 will send the results to the user device 200 to be presented the user (arrow 22). The user may be presented with the score or a message that indicates whether the verification and authentication process “failed” or successfully “verified,” or both. The result or score, or both, may be sent from the service provider app 202 to the service provider server 204 for storage (arrow 23).

In some examples, the steps occur in a different order. For instance, the telecommunications user database 222 may be contacted before the third party personal data service 220. In some examples, the steps are routed through different parties. For instance, the service provider app 202 may contact the third party personal data service 220 or the telecommunications user database 222 directly, or the system processor server 218 may connect directly to social media APIs 216. In some examples, challenge questions are generated by the social media APIs 216 (e.g., who was the last friend you tagged in a Facebook picture) or by the telecommunications user database 222 (e.g., what is the phone number you call most frequently, or what are the other phone numbers associated with your account). In some implementations, not every step or check is necessary. For instance, depending on the needs of a given merchant or service provider, social media APIs 216, third party personal data services 220 or telecommunications user databases 222 may not be contacted during the verification process.

In some examples, the system may prompt the user to place an ID document or credit card in front of the screen at a certain distance and angle from the device, matching up with markers, while the image (photograph or video) is being captured. For instance, FIG. 3 shows a wireframe 300 of an example of a user interface during the scanning (image capturing) step. A user is prompted with instructions 302 to use the camera on his device to align the document, such as the ID card 304, within brackets 306. The brackets 306 may denote the scanning area. “Scan” button 308 allows the user to take a picture or video recording to capture images to be used for forensic scanning or analysis (e.g., to verify that the ID card was validly issued by an issuing authority). In some examples, certain information can be extracted before the user takes the picture or video. For instance, the typed information 310 (such as name and address) on the front of an ID card 304 may be extracted before the user takes a picture or video of the ID card 304. In some examples, the information 310 is pulled and parsed using optical character recognition (OCR) techniques after the image or video is captured. In this example, front-facing camera 312 may be used for facial recognition in later steps. The ID picture 314 may contain a picture of the individual or user, which may be matched using facial recognition and mapping techniques. A status update bar 316 show the user where he is in the verification process.

FIG. 4 shows a wireframe 400 of an example of a user interface during the scanning (image capturing) step. The user is prompted with instructions 402 to scan the back of an ID document 404 (or any side containing a barcode 406). “Scan” button 408 allows the user to take a picture or video recording or to initiate reading of the barcode 406. These pictures or videos may be used to read the barcode 406 or conduct forensic scanning or analysis (e.g., to verify that the ID card was validly issued by an issuing authority), or both.

Either before or after capturing video or images of an ID document, the user may be asked to verify data inputted into a form, for instance the name or address inputted in a registration form or check-out field. FIG. 5 shows a wireframe 500 of an example of a user interface during this step. In this example, information 502 (such as name, date of birth, and address) from a pre-registered account or checkout field is displayed. This information 502 may be compared with information obtained from the presented or scanned ID document. The user can press the “confirm” button 504 to confirm that the information 502 is correct. A status update bar 506 shows users where they are in the verification process.

In some implementations of the system, merchants can require their users to verify against multiple forms of biometrics, including facial recognition or depth mapping and voice recognition. FIG. 6 shows a wireframe 600 of an example of a user interface during the biometric data collection step. A front-facing camera and its corresponding view 602 are displayed within a mobile device screen. Instructions 604 prompt the user to take an image (photograph or video) of his face or say his passphrase into the microphone 606. The facial image or passphrase may be matched against previously stored audio or images to verify that the same individual involved in previous verification sessions is involved in this verification session. This may allow merchants or the system processor to track the activity of an individual user over many verification sessions (and may help create a neural network of transactions and influence the final “score,” as discussed below). The facial image or passphrase may be matched against other databases, such as a government maintained database of images or voice recordings. The facial image may be matched to images associated with ID documents, such as the picture on a driver's license. The facial image or voice recording may be saved so that the user can re-access the verification session at a later point in time by re-taking a picture of his face or repeating the passphrase.

In some examples, during the verification process, users may be prompted to answer a single question or a series of questions. These may be personal questions. For instance, the questions may relate to personal financial history (e.g., last time you applied for a mortgage) or other personal history (e.g., place of birth, mother's maiden name, last 4 digits of your social security number, or marital status). FIG. 7 shows a wireframe 700 of an example of a user interface during the challenge question step. A user is presented with one or more questions 702. A user can enter his response in “answer field” 704, and press the “confirm” button 706 to submit. Instead of an “answer field” 704, there may be a drop down menu or multiple choice options, and the user can select the best answer.

In some implementations, the user is notified whether the verification process failed or succeeded. For example, FIG. 8 shows a wireframe 800 of an example of a user interface notifying the user that the user (and his ID document) was successfully verified. Store information 802 shows the name or other information about the merchant, store, payment processor, or service provider that requested verification. In some implementations, the store information 802 can be customized depending on the wishes of the merchant, store, payment processor, or service provider. In this example, check-mark 804 and “verified” text 806 indicate that the verification process was successful. This may also indicate that the “score” received by the user was above the threshold required by the merchant or payment processor. In some implementations, an x-mark or a “failed” notification will appear if the verification process was not successful or if the user's score was below the threshold required. “Register/checkout” button 808 allows the user to proceed with the activity that required verification. For instance, the user will be allowed to complete his purchase, or complete registration for a service.

Detailed information about the verification process may be available to the user, the merchant, or both (or neither). Different levels of detail may be available to different parties—for instance, the merchant may receive more detail than the user, or vice versa. FIG. 9 shows a wireframe 900 of an example of a detailed description of the verification process. In this example, a picture 902 of the user is displayed, along with name, address, and date of birth information 904. Icon 906 indicates whether the user was successfully verified, or whether the verification process failed to verify the user and his ID. Detailed list 908 shows the status of each individual part of the verification process. Although in this example every item on the list was successfully verified, in some other examples certain parts of the verification process may have failed. In some examples, the overall process may succeed (be “verified”) even if an individual part fails. In some examples, individual scores for each part of the verification process are generated and displayed. In some examples, an overall score for the verification process, representing the “best guess” for the security of the transaction, is generated and displayed. In some examples, verification history 910 is presented. For instance, the verification history can indicate the last time this user has gone through the verification process on this device.

The user interfaces may be designed by the merchant or service provider, by the system processor, or by both. The user interfaces may be uniform across a field of business (e.g., all alcohol purchases have the same user interfaces, or all government user interfaces may be the same), or may vary with each merchant or service provider. The merchant or service provider may be able to customize the user interfaces depending on the geographic location of the user, the time of year, or any factor. The merchant interface may be tailorable depending on the needs and desires of the merchant.

In some implementations, to build our verification or security system into its website or application, the merchant or service provider may be given a key or password to activate a library of native checks that can be integrated into its web services, website, or native application. The merchant may be given the library and a software development kit (SDK) for the security system service. In some implementations, the merchant or service provider may substitute its application specific key for one or more keys provided by the system processor so that the system processor is able to track or identify, for instance, the number of scans and the amount of information encrypted at each merchant or service provider application. In some implementations, an application specific key may allow the system processor server to encrypt all communications to and from the merchant or service provider application. In some implementations, the SDK provides an interface and a user interface and methods for communicating with the system processor servers.

The verification or security system may be in the form of a software as a service in which one or more features of the verification process are provided from a server and invoked as needed by the website or application of the merchant or service provider. In some implementations, the features required by the merchant's or service provider's application can be provided in a plug-in to that application or to a web browser or other online facility exposed by the merchant or service provider to its customers. The features can be made available in other ways also.

In some implementations, the system may exist as a mixture of public and private cloud components. The system processor's server may operate a web server and a database for the purposes of running multiple services on behalf of clients that can process incoming requests, archive data, analyze user activities, log all actions within the system, provide storage for the datasets required to process each request, and any combination of two or more of those facilities and others. Requests from client applications may be received in a variety of forms, sometimes tailored to the service, merchant, or business using the system.

Public requests may be made to the server through an application programming interface (API) to validate data submitted for the purpose of authentication. The system may exist on one or more machines in a virtualized or non-virtualized capacity and different components of the system may be running different operating systems depending on the services hosted in them.

In some implementations, data and requests are sent and received through secure socket connections or posts. Data can be encrypted before transmission and then uploaded to the system processor server. In some cases, all data may be encrypted using industry standard encryption at all times. Security during transmission may include registration of a token that is device-specific or app-specific or both, with the system processor's servers for each scan; server time concurrency checks; SSL encryption; a secondary layer of encryption below that of the underlying data using a standard that would include multivariate cryptography to future-proof the system against quantum computing breaches; and any combination of two or more of those and others.

In some implementations, each verification or authentication is associated with a session. That is, each time a user wishes to make a purchase or register for a site, a new session is initiated. The session code may be used for logging and tagging data. In some implementations, data is obtained, received, or processed aschychronously. In some implementations, data is obtained, received or processed sequentially.

The system may use video input or photograph input, or combinations of them. The system may be capable of using multi-media data obtained through the camera on the device (e.g., the camera on an iPhone), hardware attachments, or any other source.

Images or video of identification cards (or other items to be authenticated or verified) may be processed (e.g., sharpened, enhanced, rotated, skewed, deskewed, cropped, or de-noised, or any combination of two or more of those) by the system processor. The images or video, or both, may be analyzed using any number of techniques, including 2D barcode reading and information decoding, optical character recognition (OCR), pattern matching, template matching, and super resolution techniques, among others. Third party vision libraries may be used to implement this process. Some libraries or third party vision implements may be natively compiled to the application or may exist on system processor servers (e.g., servers owned by the system operating company), or a combination of the two.

For example, the ID may be read using OCR techniques. The ID or payment card may be classified by looking for image elements, template matching or OCR of certain text on the ID or payment card, or some combination of those techniques. For instance, the front of the card may be read with OCR techniques to determine that the payment card is a Bank of America debit card. The ID or payment card may be verified with pattern matching. The information written in text on the ID or payment card may be reconciled or compared with the information encoded in the barcode or Machine Readable Zone (MRZ) on the ID or payment card. The picture on the ID or payment card may be compared to images input using the device camera, using facial recognition or matching techniques. The registration or payment field information entered manually may be compared with information extracted from the ID or payment card, or both.

In some implementations, once the ID or payment card is classified (e.g., identified as a driver's license, military ID card, or passport), the system may use an OCR technique that is appropriate for the classified type to remove personally identifiable information. This information may include: Name, Address, Date of Birth, Date of Card Issue, Date of Card Expiration, Height, Weight, and Eye Color, among others. This information may be compared with information pulled from the ID or payment card barcode to verify that the information is consistent.

In some implementations, the ID or payment card will undergo a series of pattern matching techniques. In some cases, pattern matching requires that the system have a library of images that can be referenced. For example, this library may contain images taken with high quality scanners (600+dpi) as well as different types of mobile phones or devices (iPhone 4-5, Droid Models, Nokia Windows Phones) so that images can be referenced and matched from any mobile device, especially considering that not all devices have the same hardware specifications.

In an example of pattern matching, the system may take a slice of an ID card. This slice may encompass a particular location on the ID that contains security features or designs that are difficult to replicate on fake IDs. The location of the slice may be dictated by the system processor, and may change with time or depending on the ID. The system may run an algorithm to match the presented ID with a slice from a reference image. The pattern matching may be dictated by parameters set by the system processor. For instance, the system may look for the outline of microprint, the outline of individual characters of microprint, the placement of certain lines, or the distance between two highlights markings.

In an example of pattern matching, the system may apply similar algorithms to the entire ID card. In some implementations, the system performs both types of pattern matching (pattern matching a slice and the entire ID). In some implementations, the system performs only one type. In some implementations, the system does not use pattern matching, and looks for certain known security features without a reference image. For instance, if the state of Massachusetts has told the system processor that validly issued IDs have microprint saying “State of Massachusetts” in the top right hand corner, the system may look for that microprint without comparing to a reference image or a reference library.

In some implementations, the system looks at a barcode or MRZ code (e.g., for passports), which may be on either the front or the back of a document. The system may decode the barcode and then parse the text. Sometimes this only occurs once the ID card is classified. In some cases, the system will contain a parser, which takes the raw barcode text and removes the personal information encoded. Any parsing data can be included. The system can automatically specify where the string of text is to be parsed and then reconcile that information with information obtained via OCR techniques from other parts of the document.

Once all of the personally identifiable information from the front and barcode or MRZ of the ID are reconciled, in some implementations, information from the document (text, barcode or MRZ, or a combination of them) will be compared against previously entered registration of payment field information (form data). The system may be able to compare any set of data that is common to both the registration or payment field information (form data) and the document.

In some implementations of the system, the system can use an image (photograph or video) to auto-fill registration forms or check-out forms. For instance, the system may be able to use a picture of an ID to extract name, address, and date of birth information and input that information into an online registration or check-out form. The system may OCR the ID or extract barcode information, or both, to complete these forms.

In some implementations, the system can recognize device types (e.g., iPhones or Samsung Galaxies), and if a particular device has a front facing camera, users may be prompted to take a picture of themselves. This image may be compared, using facial recognition techniques, to the picture that is featured on the ID card.

The system may prompt users to input additional data to be cross referenced against databases of personally identifiable data from any number of firms that collect and store personal information. These may include any types of form data, including data which the user has already added to their profile or registration fields (e.g., phone number, home address, work address, or name), and social security and alpha numeric pin numbers. These may be used in subsequent transactions or logins as security tokens to allow the user to proceed without conducting the entire verification process again.

The system can also prompt users for additional security features to create a full security profile. These may include biometric data, such as facial imaging, multi-perspective facial depth imaging, voice authentication, retinal scans, and fingerprints, among others. This information may be cross-referenced against databases of personally identifiable data. This information may be used as security tokens to allow the user to proceed without conducting the entire verification process again. In some implementations, biometric information (e.g., facial imaging, fingerprint, or voice authentication) may be used to secure a user's stored information. Stored information can be saved for convenience for the next time the user must be “fully verified” on his phone. If the user chooses to “save” his session and avoid having to rescan his ID, he may need to provide a voice clip or picture of his face so that the user can be verified prior to purchase or registration. For instance, if a user presents a driver's license and a credit card, which are verified using our system, and the user's face is recognized using facial recognition patterning as matching the picture on the driver's license, then the next time the user logs-in to this service, he may not have to re-input the credit card and driver's license. Instead, the system may be able to recognize the user's facial features, associate his features with his verified documents, and allow the user to proceed. In some cases, the user may still have to input images of his driver's license and payment card again, but the additional facial recognition increases the security of the transaction and increases the user's final “score.” In some cases, facial imaging can be used to re-access a saved in-process verification process that was paused midway through.

Facial imaging requires taking an image of a user's face. In some cases, the image is stored for future reference. Multi perspective facial depth imaging requires photos from multiple angles and perspectives to create a multi-dimensional image profile of a user's face.

Voice authentication may be used an additional security token, and a user can be prompted to choose a particular phrase, sentence, or question to answer. In some examples, these passphrases may be prompted, in addition to or instead of a social security number or pin, for future transactions.

In some examples of our system, a neural network of past transactions will be generated for each user. In some cases, this is achieved by storing all information from each verification session or registration or purchase, or some combination of those. The network will grow and transform as a user adds more transactions to his profile. Variables can include, but are not limited to, purchase types, transaction types (e.g., credit card, online processor, or echeck), purchase volumes, average prices, purchase locations, frequency, time between purchases, average transaction amount or any combination of those or others. If a purchase or transaction by a user or customer does not fit the profile of that user or customer, there are many possible outcomes, depending on the system and the merchant's settings. The transaction may be flagged for further review. The transaction may not be allowed to proceed. The overall “score” for the security of that transaction may be reduced.

In some implementations, phone- or device-specific data and user form data (or data derived from an ID document, or both) are sent to a telecommunications company server (e.g., Verizon server) for the purpose of ascertaining whether that phone or device belongs to that user. This step may not be part of every verification process, and may depend on the needs and desires of the merchant, the type of device, and the identity of the telecommunications company associated with the device. In some cases, the telecommunications company does not return any sensitive data. For instance, it may merely return a “yes” or “no” in response to the data provided (a yes indicating that the user information provided matches the customer data associated with the device). In some implementations, this is information is stored with the other data obtained during the verification session.

In some implementations, associating the device with the individual and the individual's ID allows the device to act as a type of identification device. This feature may allow the user to put his “ID inside his phone,” and use his phone as an identification device for Amtrak, hotel reservations, airport security, among other situations. In some implementations, for the device to act as an ID, the user would have to demonstrate that the user has been authenticated and connected with the system processor servers. For instance, if a traveler wanted to use his mobile device as an ID at an Amtrak station, Amtrak may need a device or application to monitor for “checked in” users. In some examples, the traveler may “unlock” his identity temporarily and check in to the Amtrak station location on a map. An Amtrak employee could then see, through the Amtrak device or application, that the traveler has been recently authenticated by the system processor and is in the geographic area of the Amtrak station. The Amtrak employee may also see matching information that would be displayed on the traveler's mobile device (e.g., face, temporary personal ID number, name, or birthday, or some combination of those and others). When the traveler boards the train, he may show the Amtrak employee this matching information.

There are many possible applications for this technology. For instance, a user who is sitting in an NFL stadium may be able to purchase a beer using his device and have it delivered to his seat. Since the individual's device has been associated with an over 21 valid ID, the beer server will not have to start checking the user's ID. The beer server may have his own device showing the individual's picture, so that the beer server can verify that the device was used by the device owner.

FIG. 10 shows an example of a computing device 1000 and a mobile device 1050, which may be used with the techniques and system described here. For example, referring to FIG. 2, the user device 200 could be an example of the computing device 1000 or the mobile device 1050, and the servers 204 or 218 could include one or more computer devices 1000. Computing device 1000 is intended to represent various forms of digital computers, such as laptops, desktops, workstations, personal digital assistants, servers, blade servers, mainframes, and other appropriate computers. Mobile device 1050 is intended to represent various forms of mobile devices, such as personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 1000 includes a processor 1002, memory 1004, a storage device 1006, a high-speed interface 1008 connecting to memory 1004 and high-speed expansion ports 1010, and a low speed interface 1012 connecting to low speed bus 1014 and storage device 1006. Each of the components 1002, 1004, 1006, 1008, 1010, and 1012, are interconnected using various buses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as display 1016 coupled to high speed interface 1008. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1004 stores information within the computing device 1000. In one implementation, the memory 1004 is a volatile memory unit or units. In another implementation, the memory 1004 is a non-volatile memory unit or units. The memory 1004 may also be another form of computer-readable medium, such as a magnetic or optical disk.

The storage device 1006 is capable of providing mass storage for the computing device 1000. In one implementation, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1004, the storage device 1006, memory on processor 1002, or a propagated signal.

The high speed controller 1008 manages bandwidth-intensive operations for the computing device 1000, while the low speed controller 1012 manages lower bandwidth-intensive operations. Such allocation of functions is an example only. In one implementation, the high-speed controller 1008 is coupled to memory 1004, display 1016 (e.g., through a graphics processor or accelerator), and to high-speed expansion ports 1010, which may accept various expansion cards (not shown). In the implementation, low-speed controller 1012 is coupled to storage device 1006 and low-speed expansion port 1014. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. It may also be implemented as part of a rack server system 1024. In addition, it may be implemented in a personal computer such as a laptop computer 1022. Alternatively, components from computing device 1000 may be combined with other components in a mobile device (not shown), such as device 1050. Each of such devices may contain one or more of computing device 1000, 1050, and an entire system may be made up of multiple computing devices 1000, 1050 communicating with each other.

Computing device 1050 includes a processor 1052, memory 1064, an input/output device such as a display 1054, a communication interface 1066, and a transceiver 1068, among other components. The device 1050 may also be provided with a storage device, such as a microdrive or other device, to provide additional storage. Each of the components 1050, 1052, 1064, 1054, 1066, and 1068, are interconnected using various buses, and several of the components may be mounted on a common motherboard or in other manners as appropriate.

The processor 1052 can execute instructions within the computing device 1050, including instructions stored in the memory 1064. The processor may be implemented as a chipset of chips that include separate and multiple analog and digital processors. The processor may provide, for example, for coordination of the other components of the device 1050, such as control of user interfaces, applications run by device 1050, and wireless communication by device 1050.

Processor 1052 may communicate with a person through control interface 1058 and display interface 1056 coupled to a display 1054. The display 1054 may be, for example, a TFT LCD (Thin-Film-Transistor Liquid Crystal Display) or an OLED (Organic Light Emitting Diode) display, or other appropriate display technology. The display interface 1056 may comprise appropriate circuitry for driving the display 1054 to present graphical and other information to a person. The control interface 1058 may receive commands from a person and convert them for submission to the processor 1052. In addition, an external interface 1062 may be provide in communication with processor 1052, so as to enable near area communication of device 1050 with other devices. External interface 1062 may provide, for example, for wired communication in some implementations, or for wireless communication in other implementations, and multiple interfaces may also be used.

The memory 1064 stores information within the computing device 1050. The memory 1064 can be implemented as one or more of a computer-readable medium or media, a volatile memory unit or units, or a non-volatile memory unit or units. Expansion memory 1074 may also be provided and connected to device 1050 through expansion interface 1072, which may include, for example, a SIMM (Single In Line Memory Module) card interface. Such expansion memory 1074 may provide extra storage space for device 1050, or may also store applications or other information for device 1050. Specifically, expansion memory 1074 may include instructions to carry out or supplement the processes described above, and may include secure information also. Thus, for example, expansion memory 1074 may be provide as a security module for device 1050, and may be programmed with instructions that permit secure use of device 1050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1064, expansion memory 1074, memory on processor 1052, or a propagated signal that may be received, for example, over transceiver 1068 or external interface 1062.

Device 1050 may communicate wirelessly through communication interface 1066, which may include digital signal processing circuitry where necessary. Communication interface 1066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1068. In addition, short-range communication may occur, such as using a Bluetooth, WiFi, or other such transceiver (not shown). In addition, GPS (Global Positioning System) receiver module 1070 may provide additional navigation- and location-related wireless data to device 1050, which may be used as appropriate by applications running on device 1050.

Device 1050 may also communicate audibly using audio codec 1060, which may receive spoken information from a person and convert it to usable digital information. Audio codec 1060 may likewise generate audible sound for a person, such as through a speaker, e.g., in a handset of device 1050. Such sound may include sound from voice telephone calls, may include recorded sound (e.g., voice messages, music files, and so forth) and may also include sound generated by applications operating on device 1050. The computing device 1050 may be implemented in a number of different forms, as shown in the figure. For example, it may be implemented as a cellular telephone 1080. It may also be implemented as part of a smartphone 1082, personal digital assistant, tablet computer, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a person, the systems and techniques described here can be implemented on a computer having a display device (e.g., a CRT (cathode ray tube) or LCD (liquid crystal display) monitor) for displaying information to the person and a keyboard and a pointing device (e.g., a mouse or a trackball) by which the person can provide input to the computer. Other kinds of devices can be used to provide for interaction with a person as well. For example, feedback provided to the person can be any form of sensory feedback (e.g., visual feedback, auditory feedback, or tactile feedback). Input from the person can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a person can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Other implementations are within the scope of the following claims.

What is claimed is:

1. A method comprising
determining whether a physical device was validly issued by a party that issues physical devices that comprise security features, the determining comprising automatically processing at least a portion of a photographic or video image of the physical device to determine if the physical device comprises at least one of the security features.

2. The method of claim 1 in which the physical device comprises an identification device.

3. The method of claim 1 in which the physical device comprises a driver's license.

4. The method of claim 1 comprising presenting a question to a user based on information derived from the physical device.

5. The method of claim 1 comprising capturing the photographic or video image.

6. The method of claim 5 in which the photographic or video image is captured by a camera of a mobile device.

7. The method of claim 1 comprising displaying information about the valid issuance of the physical device to a user.

8. The method of claim 1 in which the issuing party comprises a governmental body.

9. The method of claim 1 in which the issuing party comprises a bureau of motor vehicles.

10. The method of claim 1 in which the security features comprise symbols or characters.

11. The method of claim 1 in which the security features comprise words or phrases.

12. The method of claim 1 in which the security features comprise patterns.

13. The method of claim 1 in which the security features comprise microprint.

14. The method of claim 1 in which the security features comprise spacing between symbols, characters, or lines.

15. The method of claim 1 in which processing comprises at least one of sharpening, enhancing, rotating, skewing, cropping, and de-noising at least the portion of the photographic or video image.

16. The method of claim 1 in which processing comprises reading a barcode.

17. The method of claim 1 in which processing comprises optical character recognition.

18. The method of claim 17 comprising classifying the physical device using optical character recognition.

19. The method of claim 17 comprising extracting information about an individual from the physical device using optical character recognition.

20. The method of claim 1 in which processing comprises pattern matching.

21. The method of claim 20 in which at least the portion of the photographic or video image is compared to a reference photographic or video image.

22. The method of claim 1 in which processing comprises template matching.

23. The method of claim 1 in which processing comprises the use of super resolution techniques.

24. The method of claim 1 in which processing is based on vision libraries.

25. The method of claim 1 comprising determining a score, the score at least in part based on a probability that the physical device was validly issued by the issuing party.

26. The method of claim 25 in which the score is at least in part based on a probability that an individual purporting to be associated with the physical device is associated with the physical device.

27. The method of claim 26 in which the physical device comprises a payment device.

28. The method of claim 26 in which the physical device comprises an identification device.

29. The method of claim 1 comprising determining from the physical device information about a person who is associated with the physical device.

30. The method of claim 29 in which the information about the person comprises identification information.

31. The method of claim 1 comprising determining that a person who has a purported identity and is associated with the physical device, has an actual identity that matches the purported identity.

32. The method of claim 31 in which the determining comprises receiving information from the person independently of information that is part of the physical device.

33. The method of claim 31 comprising deriving from the physical device information about a person who is associated with the physical device and determining if there is a match between the derived information and the actual identity of the person.

34. A method comprising
determining whether an individual identified by a physical identification device is associated with a mobile device that is identified by a unique token, the determining comprising
deriving identification information from at least a portion of a photographic or video image of the identification device;
using the unique token to determine an identity of a customer who is associated with the mobile device; and
comparing the identity of the customer with the identification information derived from the identification device.

35. The method of claim 34 in which the identification information comprises a photograph.

36. The method of claim 34 in which the identification information comprises symbols or characters.

37. The method of claim 34 in which the mobile device comprises a mobile phone.

38. The method of claim 34 comprising capturing a photographic or video image using the mobile device.

39. The method of claim 34 in which the unique token comprises a phone number.

40. The method of claim 34 in which the unique token comprises a universally unique identifier.

41. The method of claim 34 in which the unique token comprises a media access control address.

42. The method of claim 34 in which the unique token is used to identify the customer at a location other than the location of the mobile device.

43. The method of claim 34 in which the unique token is used to identify the customer using customer records of a telecommunications company.

44. A method comprising
using a camera to capture an image of an identification device;
automatically comparing at least a portion of the image to images of officially issued identification devices to determine whether the presented device is, within a forensic standard, an officially issued identification device; and
providing an indication whether the presented identification device is determined to be an officially issued identification device.

45. A method comprising
using a mobile device to capture an image of an identification device; and
automatically comparing features captured in the image to known features of validly issued identification devices of an issuing entity to determine whether the presented identification device was, within a forensic standard, issued by the issuing entity.

46. The method of claim 45 comprising automatically comparing information derived from the identification device to information from other sources to determine whether the identification device identifies an individual it purports to identify.

47. The method of claim 46 in which the information derived from other sources comprises email or phone contacts.

48. The method of claim 46 in which the information derived from other sources comprises customer information associated with the mobile device.

49. The method of claim 46 in which the information derived from other sources comprises information in the control of a fraud detection service.

50. A method comprising
obtaining an image of a physical device captured using a mobile device;
deriving information from at least a portion of the image of the physical device;
comparing the identity of the individual associated with the mobile device with information derived from the physical device.

51. A method comprising
initiating an activity which, to complete, requires identification of the initiating individual;
using a mobile device to capture an image of an identification device; and
completing the activity.

52. The method of claim 51 in which the activity is an online purchase.
